(19) United States
(12) Patent Application Publication
(10) Pub. No.: US 2025/0268790 A1
(43) Pub. Date: Aug. 28, 2025

(54) Medication packaging

(71) Applicant: KNAPP AG, Hart bei Graz (AT)

(72) Inventor: Jürgen Geßner, München (DE)

(21) Appl. No.: 18/855,021

(22) PCT Filed: Apr. 6, 2023
(86) PCT No.: PCT/EP2023/059168

§ 371 Date: Oct. 8, 2024

(30) Foreign Application Priority Data
Apr. 8, 2022 (DE) 10 2022 108 586.4
Jun. 2, 2022 (DE) 10 2022 114 007.5

(51) Int. Cl. A61J 1/03; A61J 7/04; B65D 75/36

(52) U.S. Cl. CPC A61J 1/035; A61J 7/04; B65D 75/367

(57) ABSTRACT

A medication package comprising an upper foil and a lower foil, wherein the upper foil and the lower foil are connected to one another along several lines, wherein a first group of compartments is provided, the compartments of which are arranged one after the other in a longitudinal direction, wherein the respective compartment is limited at the top by a part of the upper foil and at the bottom by a part of the lower foil, wherein a front compartment and a rear compartment immediately subsequent to it in the longitudinal direction is separated by one of the lines connecting the upper foil to the lower foil, at least one compartment of the first group having at least one pill arranged in it, wherein a second compartment is limited at the top by a part of the upper foil and at the bottom by a part of the lower foil, a front compartment being separated from a rear compartment that is immediately subsequent to it in the longitudinal direction.

### CROSS-REFERENCE TO RELATED APPLICATIONS

This application is a national stage application under 35 U.S.C. § 371 of International Patent Application No. PCT/EP2023/059168 filed on Apr. 6, 2023, which claims priority to DE 10 2022 108 586.4 filed on Apr. 8, 2022, and DE 10 2022 114 007.5 filed on Jun. 2, 2022, the subject matter of which is incorporated by reference herein in its entirety for all purposes.

### FIELD OF INVENTION

The invention relates to a medication package.

### BACKGROUND

Medications in pill form are often packaged in what are known as blisters. A blister usually has a lower material, often made of opaque plastic, sometimes in the form of a deep-drawn element with several troughs, each containing a pill. A blister usually exhibits an upper material, usually aluminum, which covers the troughs of the lower material and is connected to the lower material in the surfaces between the troughs.

Recently, patient-specific pharmaceutical blister packs have become known, in which a patient's medication is put together and packaged in individual portions according to the doctor's prescribed dosage. Within this concept, it is intended that the drugs be removed from their original packaging (blister-packed) and repackaged in cup blisters or blister cards or tubular blisters. Cup blisters and blister cards usually contain seven days' medication. With tubular bags, sachets are provided for each time the medication is to be taken, with each sachet containing the prescribed and packaged medication for that particular time. The blisters usually consist of plastic that can be disposed of in the recycling bin.

A tubular blister is a medication package with an upper foil and a lower foil, the upper foil and the lower foil being connected to each other along several lines, with compartments being provided as part of the tubular blister, which are arranged one after the other in a longitudinal direction, with the respective compartment being limited at the top by a part of the upper foil and at the bottom by a part of the lower foil, a front compartment being separated from a compartment directly subsequent to it in the longitudinal direction by one of the lines connecting the upper foil to the lower foil, wherein at least one pill is arranged in each of the compartments of the tubular blister.

The disadvantage of the usual arrangement of compartments in a tubular blister, one after the other in a longitudinal direction, is that there is a risk that a patient who has forgotten to take the pill from a compartment at the intended time (Thursday evening), to empty this compartment at the next time of taking pills (e.g. on Friday morning) and thus take the pill inside at the wrong time. Sometimes two separate compartments are provided for a single timing of taking pills. This may be the case if the patient has to take more pills at the time of taking pills than can technically be filled into one compartment or can technically be checked as present in one compartment. In such cases, the pills to be taken at a particular time may be distributed among several compartments.

Against this background, the invention was based on the task of creating a medication package that at least essentially retains the advantages of a tubular blister, in particular with regard to the cost of materials and/or with regard to production but allows more specific access to the respective compartment of the medication package.

### SUMMARY

The invention is based on the basic idea of providing, in addition to a first group of compartments whose compartments are arranged one after the other in a longitudinal direction, at least a second group of compartments whose compartments are arranged one after the other in a longitudinal direction, wherein the respective compartment is limited at the top by a part of the upper foil and limited at the bottom by a part of the lower foil, wherein a front compartment is separated from a compartment directly subsequent to it in the longitudinal direction by one of the lines connecting the upper foil to the lower foil, wherein at least one pill is arranged in at least one compartment of the second group. The invention also makes it possible to provide the matrix-like arrangement of compartments, as is known, for example, from blister cards, in the context of tubular blisters. This means that the advantages of tubular blisters, in particular with regard to the use of materials and ease of production, are retained, while the advantages of specific access to individual compartments at the respective timing of taking pills in the context of a matrix-like arrangement, as known from blister cards, are made possible.

The medication package according to the invention exhibits an upper foil and a lower foil. The upper foil and the lower foil can be separate foils that are connected to each other at designated locations to form the medication package. However, embodiments are also possible in which the upper foil and the lower foil are parts of a single-piece element. To produce the medication package, a sheet can be taken, folded once and the sheet material on one side of the fold, which then forms the upper foil, is placed on the sheet material on the other side of the fold, which then forms the lower foil. Likewise, embodiments are possible in which the upper foil and the lower foil are part of a tube that is bent at two parallel areas so that one part of the tube forms the upper foil, and another part of the tube forms the lower foil, with the upper foil merging into the lower foil at two opposite bends.

The upper foil and the lower foil are connected to each other along several lines. In a preferred embodiment, the lines along which the upper foil and the lower foil are connected to each other are arranged in a grid. In a preferred embodiment, a first group of lines is provided that run parallel to one another, and a second group of lines is provided that also run parallel to one another, but with the lines of the first group being arranged at an angle, preferably at an angle of 90°, to the lines of the second group. In a preferred embodiment, at least one line of the lines of the first group crosses a line of the lines of the second group. In a particularly preferred embodiment, each line of the first group crosses the plurality, preferably the vast plurality (more than 75%), of the lines of the second group and more preferably crosses each of the lines of the second group.

In a preferred embodiment, the upper foil is connected to the lower foil along the respective line throughout. Embodiments are possible in which the upper foil is connected to the lower foil along the respective line only along sections of the line in the form of lines or at points arranged along the line. Embodiments are possible in which the upper foil is connected to the lower foil along the respective line in the manner of a dotted line or in the manner of a dashed line or in the manner of a line with dots. However, the fact that the upper foil is only partially connected to the lower foil along the respective line carries the risk of contamination of the pill arranged in one compartment with abrasion or dust from a pill arranged in an adjacent compartment. It is therefore particularly preferred if the upper foil and the lower foil are completely connected to one another along the respective line. In a preferred embodiment, the upper and lower foils are welded to one another along at least one of the lines along which they are joined to one another. Preferably, the upper foil and the lower foil are welded to one another along the majority, preferably the vast majority (more than 75%), and more preferably along all of the lines along which they are joined to one another. In a preferred embodiment, the upper foil and lower foils are glued to one another along at least one of the lines along which they are connected to one another. Preferably, the upper foil and the lower foil are glued to one another along the majority, preferably the vast majority (more than 75%), and in particular along all lines along which they are connected to one another. Embodiments are possible in which the upper foil and the lower foil are glued and welded to one another along the majority, preferably the vast majority (more than 75%), and in particular along all the lines along which they are connected to one another.

A line along which the upper and lower foils are joined together is preferably more than 0.5 mm wide, preferably more than 1 mm wide, and preferably more than 1.5 mm wide. A line along which the upper and lower foils are joined together is preferably less than 15 mm wide, preferably less than 10 mm wide, and preferably less than 5 mm wide.

In a preferred embodiment, a material weakening or a partial material breakthrough in the upper and/or lower foil is provided in the area of at least one line, preferably in the area of the majority of the lines, particularly preferably in the area of the vast majority (more than 75%), and in a preferred embodiment in the area of all lines along which the upper foil is connected to the lower foil, to form a separating aid. For example, a perforation or a serrated profile can be provided along the lines. These are intended to make it easier to destroy the connection provided there between the upper and lower foils, for example by tearing. In order to provide sufficient space for a weakening or partial breakthrough of the material, it is preferred that the line along which the upper foil is connected to the lower foil exhibits a certain width. In particular, the width is preferred to ensure that after a compartment is separated, the remaining compartment still remains securely closed, that is, the connections between the upper foil and the lower foil for the remaining compartment are safely preserved. The wider the line along which the upper foil is connected to the lower foil, the more it is ensured that a remaining compartment remains securely closed.

In a preferred embodiment, there are provided a plurality of lines along which the upper foil is connected to the lower foil, wherein in a preferred embodiment, at least for some of these lines, a material weakening or a partial material breakthrough in the upper and/or lower foil is provided in the area of the respective line to form a separating aid, wherein in a particularly preferred embodiment the type of material weakening or the type of partial material breakthrough in the area of one of these lines is different from the type of material weakening or the type of partial material breakthrough in the area of another of these lines. In the area of one line, the material weakening can be stronger (the area can be weakened more) than in the area of another line. In the area of one line, the partial material breakthrough can be stronger (the area exhibits more broken-through parts) than in the area of another line. In a preferred embodiment, one of the lines, in the area of which the type of material weakening or the type of partial material breakthrough is different from the area of another line, is not parallel to the other line and is preferably at an angle of more than 40°, preferably at an angle of more than 80° and particularly preferably at an angle of less than 140° and most particularly at an angle of less than 100°. In particular, in the case of a line that, as described in the part below, in a preferred embodiment separates the compartments of a first group from the compartments of a second group, the type of material weakening or the type of partial material breakthrough in the area of this line can be designed differently than the type of material weakening or the type of partial material breakthrough of a line that separates individual compartments of the first group. By choosing different types of material weakening or partial material breakthrough, it may be easier to separate the medication package in one direction than in the other direction. For example, a medication package that is designed for a week and has three times of taking pills per day (morning, noon, evening) and therefore exhibits three groups of seven compartments each, can be designed so that the compartments corresponding to the individual days that the compartments corresponding to the individual days can be more easily separated from the compartments of another day than the compartments corresponding to the different timings of taking pills within one day. A medication package according to the invention, which extends in a longitudinal direction and in which the compartments provided for the individual days of the week are arranged one behind the other in the longitudinal direction and the compartments that correspond to the different times of taking pills within a day extend transversely to the longitudinal direction, can be more easily separated transversely to the longitudinal direction than along the longitudinal direction. This makes it easier for a user to separate the compartments corresponding to one day of the week from the compartments of another day of the week more easily and in one piece, while the compartments belonging to one day of the week remain contiguous during this separation.

In the case of perforation, the type of perforation can be changed by the number of perforation points and/or the size of the perforation points. In the case of a serrated profile, the type of material weakening can be changed by the course of the serrations.

The medication package exhibits a first group of compartments, the compartments of the first group being arranged one after the other in a longitudinal direction, with the respective compartment being limited at the top by a part of the upper foil and at the bottom by a part of the lower foil. A front compartment is separated from a rear compartment that is immediately subsequent to it in the longitudinal direction by one of the lines connecting the upper foil to the lower foil. In a preferred embodiment, for a plurality of the compartments present in the first group, in particular the vast majority (more than 75%) of the compartments present in the first group, in particular for all compartments present in the first group, the respective front compartment of two immediately subsequent compartments is separated from the compartment directly subsequent to it in the longitudinal direction by one of the lines. As described in detail above, in a preferred embodiment, in the area of a line along which the upper foil is connected to the lower foil, a material weakening or a partial material breakthrough in the upper and/or lower foil may be provided to form a separating aid; for example, a perforation or a serrated profile may be provided along the lines. The line(s) described in this paragraph may be lines in the area of which a material weakening or partial material breakthrough is provided in the upper and/or lower foil to form a separating aid.

In a preferred embodiment, the majority of the compartments, in particular the vast majority of the compartments of the first group, and in particular all compartments of the first group, are rectangular, in particular square or, alternatively, in particular rectangular but not square. However, other designs are also possible, for example, in which the compartments are arranged next to each other in the manner of honeycombs. In a preferred embodiment, the majority of the compartments, in particular the vast majority of the compartments, are longer in a first direction (“length”) than in a second direction (“width”), which is perpendicular to the first direction, and/or than in a third direction (“height”), which is perpendicular to the first and second directions.

Designs are also possible in which the majority of the compartments, in particular preferably the vast majority of the compartments of the first group, exhibit an identical geometric shape, but at least one compartment of the first group has a different geometric shape than other compartments of the first group. In a preferred embodiment, the majority of the compartments, in particular the vast majority of the compartments, of the first group are the same size. In a preferred embodiment, all compartments of the first group are the same size. In an alternative embodiment, the majority of the compartments, in particular the vast majority of the compartments, of the first group are larger or smaller than at least one other compartment of the first group.

Assuming the use of the medication package according to the invention, in which the compartments of a group contain pills that are taken at the same time of day but on different days, for example, a group of compartments is assigned to the “morning” time of taking pills, it may be that, within a week, a different number of pills have to be taken at the same time of taking pills (for example, “morning”) For example, it may be provided that fewer pills have to be taken on a weekend day (Saturday or Sunday). In such a case, it may be provided in a preferred embodiment that the compartments of the weekdays (e.g. Monday to Friday) on which many pills have to be taken at the time of taking pills (e.g. “in the morning”) are larger than the compartments of the weekdays (e.g. Saturday and Sunday) on which fewer pills have to be taken at the time of taking pills.

In a preferred embodiment of the rectangular compartments, at least one, preferably the majority and in particular the vast majority (more than 75%) and in particular all rectangular compartments of the first group are limited by lines at which the upper foil is connected to the lower foil. Embodiments are possible in which a compartment is limited, for example, by only three lines because the fourth limitation is formed by the kink at which a sheet of material for forming the upper and lower foils was bent or at which a tube for forming the upper and lower foils was bent. However, since the methods of connecting the upper foil to the lower foil, for example by welding or gluing, can be used to produce a tight connection between the upper and lower foils particularly well and securely, it is preferred if the respective compartment is limited at all its limitations by lines where the upper foil is connected to the lower foil.

According to the invention, at least one pill is arranged in at least one compartment of the first group. Preferably, at least one pill is arranged in the majority, preferably in the vast majority (more than 75%), preferably in all compartments of the first group.

According to the invention, it is now provided that the medication package exhibits a second group of compartments, the compartments of the second group being arranged one after the other in a longitudinal direction, the respective compartment being limited at the top by a part of the upper foil and at the bottom by a part of the lower foil wherein a front compartment of the second group is separated from a compartment directly subsequent to it in the longitudinal direction by one of the lines connecting the upper foil to the lower foil, wherein at least one pill is arranged in at least one compartment of the further group.

In a preferred embodiment, for a majority of the compartments present in the second group, in particular for the vast majority (more than 75%) of the compartments present in the second group, in particular for all compartments present in the second group, the respective front compartment of two compartments that directly follow one another is separated from the compartment that is directly subsequent to it in the longitudinal direction by one of the lines. As described in detail above, in a preferred embodiment, in the area of a line along which the upper foil is connected to the lower foil, a material weakening or a partial material breakthrough in the upper and/or lower foil may be provided to form a separating aid; for example, a perforation or a serrated profile may be provided along the lines. The line(s) described in this paragraph may be lines in the area of which a material weakening or partial material breakthrough is provided in the upper and/or lower foil to form a separating aid.

In a preferred embodiment, the majority of the compartments, in particular the vast majority of the compartments, of the second group, and in particular all of the compartments of the second group, are rectangular, in particular square or, alternatively, in particular rectangular but not square. In a preferred embodiment, the majority of the compartments, in particular the vast majority of the compartments, of the second group, and in particular all compartments, of the second group, are longer in a first direction (“length”) than in a second direction (“width”), perpendicular to the first direction, and/or than in a third direction (“height”), perpendicular to the first and second directions.

Designs are also possible in which the majority of the compartments, in particular preferably the vast majority of the compartments of the second group, exhibit an identical geometric shape, but at least one compartment of the second group has a different geometric shape than other compartments of the second group. In a preferred embodiment, the plurality of compartments, in particular the vast majority of compartments of the second group, are the same size. In a preferred embodiment, all compartments of the second group are the same size. In an alternative embodiment, the majority of compartments, in particular the vast majority of compartments of the second group, are larger or smaller than at least one other compartment of the second group.

Assuming the use of the medication package according to the invention, in which the compartments of a group contain pills that are taken at the same time of day but on different days, for example, a group of compartments is assigned to the timing of taking pills “at noon”, it may be that, within a week, a different number of pills have to be taken at the same time of day (e.g. “at noon”) depending on the day of the week. For example, it may be provided that fewer pills have to be taken on a weekend day (Saturday or Sunday). In such a case, it may be provided in a preferred embodiment that the compartments of the weekdays (e.g. Monday to Friday) on which many pills have to be taken at the time of taking pills (e.g. “at noon”) are larger than the compartments of the weekdays (e.g. Saturday and Sunday) on which fewer pills have to be taken at the time of taking pills (e.g. “at noon”).

In a preferred embodiment of the rectangular compartments, at least one, preferably the majority and more preferably the vast majority (more than 75%) and more preferably all rectangular compartments of the second group are limited by lines where the upper foil is connected to the lower foil. Embodiments are possible in which a compartment is limited, for example, by only three lines because the fourth limitation is formed by the kink at which a sheet of material for forming the upper and lower foils was bent or at which a tube for forming the upper and lower foils was bent. However, since the methods of connecting the upper foil to the lower foil, for example by welding or gluing, can be used to produce a tight connection between the upper and lower foils particularly well and securely, it is preferred if the respective compartment is limited at all its limitations by lines where the upper foil is connected to the lower foil.

In a preferred embodiment, the majority of the compartments, in particular the vast majority of the compartments of the first group and the majority of the compartments, in particular the vast majority of the compartments of the second group, are the same size. In a preferred embodiment, all compartments of the first group and all compartments of the second group are the same size.

In a preferred embodiment, the majority of the compartments, in particular the vast majority of the compartments, of the first group are larger or smaller than the majority of the compartments, in particular the vast majority of the compartments, of the second group. In a preferred embodiment, all of the compartments of the first group are smaller or larger than all of the compartments of the second group.

Assuming the use of the medication package according to the invention, in which the compartments of a group contain pills that are taken at the same time of day but on different days, for example, a first group of compartments is assigned to the timing of taking pills “in the morning”, while a second group of compartments is assigned to the “noon” timing of taking pills, it may be that, for one timing of taking pills (e.g., in the morning), relatively more pills must be taken than at another timing (e.g., at noon). In such a case, a preferred embodiment may provide that the compartments of one group, in which many pills have to be taken at the time of taking (e.g. “in the morning”), are larger than the compartments of the other group, in which fewer pills have to be taken at the time of taking (e.g. “at noon”). This can then be combined with the above-described teaching of varying the size of the compartments within a group, for example, if more pills need to be taken at a certain time of the week (for example Monday through Friday) than on certain other days of the week (for example Saturday and Sunday). Finally, it is possible to combine this teaching with the also described teaching of leaving individual compartments empty.

According to the invention, at least one pill is arranged in at least one compartment of the second group. Preferably, at least one pill is arranged in the majority, preferably in the vast majority (more than 75%), preferably in all compartments of the second group.

Embodiments are possible in which individual compartments are deliberately left empty. If the medication package according to the invention reflects the timing of taking pills over the course of a week through its shape and arrangement of the groups of compartments, and if, for example, it has three groups with seven compartments each (for the timing of taking pills in the morning, at noon, and in the evening on the seven days of the week), it may be that no medication is to be taken at a certain time; for example, no medication is to be taken on Sunday morning. The compartment corresponding to the timing of taking pills “Sunday morning” would then be left empty but would be available.

In a preferred embodiment, a compartment of the first group is separated from an adjacent compartment of the second group by one of the lines connecting the upper foil to the lower foil. In a preferred embodiment, the majority, preferably the vast majority (over 75%), and in particular all compartments of the first group are arranged adjacent to a compartment of the second group. In a preferred embodiment, the compartment of the first group is separated from the adjacent compartment of the second group by one of the lines connecting the upper foil to the lower foil. As described in detail above, in a preferred embodiment, in the area of a line along which the upper foil is connected to the lower foil, a material weakening or a partial material breakthrough in the upper and/or lower foil can be provided to form a separating aid; for example, a perforation or a serrated profile can be provided along the lines. The line(s) described in this paragraph may be lines in the area of which a material weakening or a partial material breakthrough is provided in the upper and/or lower foil to form a separating aid. In particular, in the case of a line that separates the compartments of a first group from the compartments of a second group, the type of material weakening or the type of partial material breakthrough in the area of this line may be different from the type of material weakening or the type of partial material breakthrough of a line that separates individual compartments of the first group.

In a particularly preferred embodiment, a further group of compartments is provided, the compartments of the further group being arranged one after the other in a longitudinal direction, the respective compartment being limited at the top by a part of the upper foil and at the bottom by a part of the lower foil, a front compartment being separated from a compartment directly subsequent to it in the longitudinal direction by one of the lines connecting the upper foil to the lower foil, wherein at least one pill is arranged in at least one compartment of the further group.

In a preferred embodiment, for a majority of the compartments present in the further group, in particular preferably the vast majority (more than 75%) of the compartments present in the further group, in particular preferably for all compartments present in the further group, the respective front compartment of two immediately subsequent compartments is separated from the compartment directly following it in the longitudinal direction by one of the lines. As described in detail above, in a preferred embodiment, in the area of a line along which the upper foil is connected to the lower foil, a material weakening or a partial material breakthrough in the upper and/or lower foil may be provided to form a separating aid; for example, a perforation or a serrated profile may be provided along the lines. The line(s) described in this paragraph may be lines in the area of which material weakening or a partial material breakthrough is provided in the upper and/or lower foil to form a separating aid.

In a preferred embodiment, the majority of the compartments, in particular the vast majority of the compartments, of the further group and in particular all compartments of the further group are rectangular, in particular square, or alternatively in particular rectangular but not square. Designs are also possible in which the majority of the compartments, in particular preferably the vast majority of the compartments of the further group, exhibit an identical geometric shape, but at least one compartment of the further group has a different geometric shape than the other compartments of the further group. In a preferred embodiment of the rectangular compartments, at least one, preferably the majority and in particular the vast majority (more than 75%) and in particular all rectangular compartments of the further group are limited by lines at which the upper foil is connected to the lower foil. Embodiments are possible in which a compartment is limited, for example, by only three lines because the fourth limitation is formed by the kink at which a sheet of material for forming the upper and lower foils was bent or at which a tube for forming the upper and lower foils was bent. However, since the methods of connecting the upper foil to the lower foil, for example by welding or gluing, can be used to produce a tight connection between the upper and lower foils particularly well and securely, it is preferred if the respective compartment is limited at all its limitations by lines where the upper foil is connected to the lower foil.

According to the invention, at least one pill is arranged in at least one compartment of the further group. Preferably, at least one pill is arranged in the majority, preferably in the vast majority (more than 75%), preferably in all compartments of the further group in the respective compartment.

In a preferred embodiment, a compartment of the second group is separated from an adjacent compartment of the further group by one of the lines connecting the upper foil to the lower foil. In a preferred embodiment, the majority, preferably the vast majority (over 75%), and in particular all compartments of the second group are arranged adjacent to a compartment of the further group. In a preferred embodiment, the compartment of the second group is separated from the adjacent compartment of the further group by one of the lines connecting the upper foil to the lower foil. As described in detail above, in a preferred embodiment, in the area of a line along which the upper foil is connected to the lower foil, a material weakening or a partial material breakthrough in the upper and/or lower foil can be provided to form a separating aid; for example, a perforation or a serrated profile can be provided along the lines. The line(s) described in this paragraph may be lines in the area of which a material weakening or a partial material breakthrough is provided in the upper and/or lower foil to form a separating aid. In particular, in the case of a line separating the compartments of a second group from the compartments of a further group, the type of material weakening or the type of partial material breakthrough in the area of this line may be different from the type of material weakening or the type of partial material breakthrough of a line separating individual compartments of the second group.

In a preferred embodiment, the number of groups of compartments present is chosen according to the number of times that pills are taken in a day. If a medication plan is provided for the respective patient that provides for taking pills in the morning, at noon and in the evening, then the medication package according to the invention preferably exhibits three groups. If the medication plan for the respective patient provides for a further timing of taking pills at night in addition to a timing of taking pills in the morning, at noon and in the evening, then four groups of compartments are provided in particular. Consequently, the number of groups can be adapted to the number of timings of taking pills per day.

In a preferred embodiment, the first group contains seven compartments and/or the second group contains seven compartments. By providing seven compartments per group, the seven days of a week can be represented. Thus, the medication package according to the invention can be used to provide a medication plan for a week. In a preferred embodiment, all groups of compartments exhibit the same number of compartments.

In a preferred embodiment, the longitudinal direction along which the compartments of the first group are arranged is parallel to the longitudinal direction along which the compartments of the second group are arranged. If a further group of compartments or further groups of compartments are provided, it is preferred if the longitudinal directions along which the compartments of these groups are arranged are also parallel to the longitudinal direction along which the compartments of the first group are arranged.

In a preferred embodiment, more than one pill is arranged in at least one compartment of the medication package, preferably in the majority, particularly preferably in the vast majority (in more than 75%) and particularly preferably in all compartments of the medication package.

In a preferred embodiment, two pills are arranged in at least one compartment, which differ from each other, in particular with regard to their chemical composition and/or different in terms of their geometric shape and/or in terms of their size.

There are also possible embodiments in which, for example, one compartment of the medication package is without a pill. Depending on the patient's medication schedule, it is conceivable, for example, that the patient's medication schedule does not provide for taking a medication at a timing of taking pills that arises from the grid, for example Saturday at noon. However, this is not a problem for implementing the invention, since in such a case the respective compartment is simply left empty.

In a preferred embodiment, printing is provided on the upper side of the upper foil and/or on the lower side of the lower foil. In a preferred embodiment, printing is provided on the upper side of the upper foil and/or on the lower side of the lower foil, at least in the area of one compartment of the medication package, preferably in the area of the majority, preferably the vast majority (more than 75%), more preferably all compartments. The respective compartments can be labeled with the printing. The printing can describe the contents of the compartment or the medication package. The printing can describe the day of taking a medication present in the compartment. The printing can describe the time of taking a medication present in the compartment.

In a preferred embodiment, the medication package exhibits a frame that runs around the compartments present and in which the upper foil is directly connected to the lower foil. An immediate connection is understood to mean a connection without the formation of a compartment. It is known from blister cards that the cardboard used to form the blister card encompasses a central area, in which the individual troughs containing the pills are located, in the sense of a surrounding frame. Such a frame can give the medication package a structure. In addition, such a frame can be used to hold the medication package well. Furthermore, such a frame can be used to transport the medication package according to the invention, for example by roller drives that run on the frame. Likewise, designs are possible in which the frame of the medication package is used to hold the medication package in a separate reinforcing and/or transport frame, for example by means of a cover card. Likewise, such a frame can be used for labeling. The labeling can describe the contents of the compartment or the medication package. The labeling can describe the day of ingestion of a medication present in the compartment. The labeling can describe the time of ingestion of a medication present in the compartment.

In a preferred embodiment, the upper foil and the lower foil are made of the same material.

In a preferred embodiment, the material of the upper foil has food-safe, water-vapor-resistant material properties. In a preferred embodiment, the material of the lower foil has food-safe, water-vapor-resistant material properties.

The upper and/or lower foil may be a foil made of LDPE (low-density polyethylene). The foils can be processed using a standard bar welding machine. The foil may be 100 my, but may also be 25 my or 50 my.

In a preferred embodiment, the material of the upper foil is transparent. In a preferred embodiment, the material of the lower foil is transparent.

### BRIEF DESCRIPTION OF THE DRAWINGS

The subsequent description of the invention is based on a figures that illustrates only one example of the invention. The drawing shows:

FIG. 1 a schematic top view of a medication package according to the invention;

FIG. 2 a sectional view of the medication package along line B-B according to FIG. 1 and

FIG. 3 detail C from FIG. 2 in an enlarged view.

### DETAILED DESCRIPTION

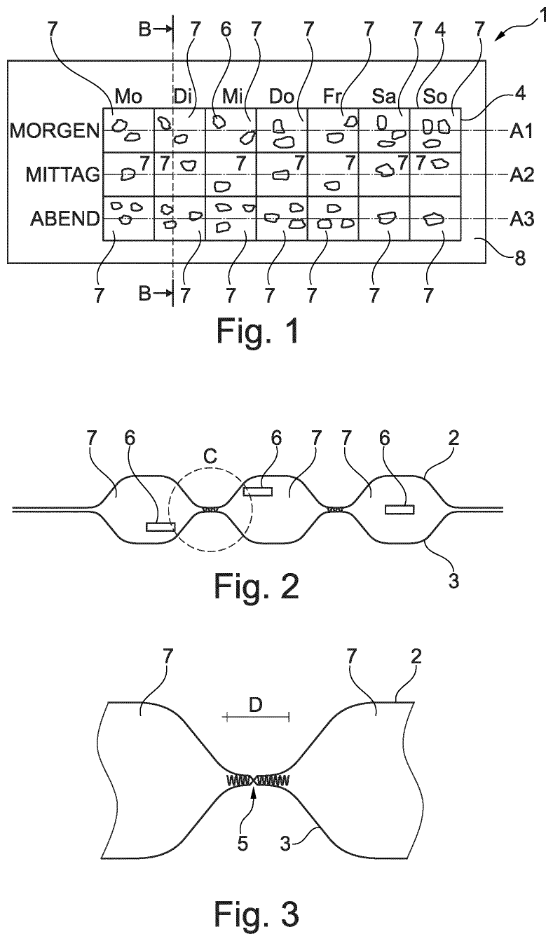

The medication package 1 shown in FIG. 1 exhibits an upper foil 2 and a lower foil 3. The upper foil 2 and the lower foil 3 are connected to each other along several lines 4. In the embodiment of FIG. 1, the lines 4 form a grid. A first group of lines 4 with eight vertical lines is provided. A second group of four horizontal lines 4 is provided. Each horizontal line intersects each vertical line once. The upper foil 2 and the lower foil 3 are joined along the respective line 4 by means of a weld. The width D of the line 4 is shown in FIG. 3. This is chosen to be large enough to provide a partial material breakthrough 5 in the upper foil 2 and the lower foil 3 in the area of line 4. The material breakthrough 5 is a punctiform material breakthrough and part of a line of punctiform material breakthroughs that extend along the line 4 and serve as a separating aid. The width D is chosen so that even after separation at the material breakthrough 5, sufficient welded material remains to hold the pill 6 in the respective compartment 7.

The medication package 1 exhibits a first group, a second group and a further, namely a third group of compartments 7. The compartments 7 of the respective group are arranged one after the other along a longitudinal direction A1, A2, A3, the respective compartment of the respective group being limited at the top by a part of the upper foil 2 and at the bottom by a part of the lower foil 3 (see FIG. 2). A front compartment 7, for example a compartment 7 arranged further to the left in FIG. 1, is separated from a compartment directly subsequent to it in the longitudinal direction A1, A2 or A3, that is to say the compartment 7 arranged directly to the right of it in FIG. 1, by one of the lines 4 connecting the upper foil 2 to the lower foil 3. As shown in FIG. 1, at least one pill 6 is arranged in each compartment 7 of the respective group.

FIG. 1 shows that the longitudinal directions A1, A2, A3 of the respective group are parallel to one another.

The first group has seven compartments 7, the second group has seven compartments 7 and the third group also has seven compartments 7. Thus, the medication package 1 exhibits 21 compartments 7.

FIG. 1 shows that medication package 1 exhibits printing at various points on the upper side of the upper foil. In the embodiment of FIG. 1, the days of the week (Mo, Tu, We, Th, Fr, Sa, Su) and the timing of taking pills (morning, noon, evening) are indicated by printing.

The medication package 1 exhibits a frame 8 that runs around the existing compartments 7 and in which the upper foil 2 is directly connected to the lower foil 3.

1.-10. (canceled)

11. A medication package comprising
an upper foil; and
a lower foil (3);
wherein the upper foil and the lower foil are connected to one another along a plurality of lines, wherein a first group of compartments is provided, the compartments of which are arranged one after the other along a longitudinal direction (A1), wherein the respective compartment is limited at the top by a part of the upper foil and at the bottom by a part of the lower foil, wherein a front compartment is separated from a compartment directly subsequent to it in the longitudinal direction (A1) by one of the lines connecting the upper foil to the lower foil, wherein at least one pill is arranged in at least one compartment of the first group, wherein the package further comprises a second group of compartments, the compartments of which are arranged one after the other in a longitudinal direction (A2), the respective compartment being limited at the top by a part of the upper foil and at the bottom by a part of the lower foil, a front compartment being separated from a compartment directly subsequent to it in the longitudinal direction (A2) by one of the lines connecting the upper foil to the lower foil, wherein at least one pill is arranged in at least one compartment of the second group.

12. The medication package according to claim 11, wherein the longitudinal direction (A1) along which the compartments of the first group are arranged runs parallel to the longitudinal direction (A2) along which the compartments of the second group are arranged.

13. The medication package according to claim 11, further comprising at least one further group of compartments, the compartments of which are arranged one after the other in a longitudinal direction (A3), wherein the respective compartment is limited at the top by a part of the upper foil and at the bottom by a part of the lower foil, wherein a front compartment is separated from a compartment directly subsequent to it in the longitudinal direction (A3) by one of the lines connecting the upper foil to the lower foil, wherein at least one pill is arranged in at least one compartment of the further group.

14. The medication package according to claim 11, wherein the first group contains seven compartments and/or the second group contains seven compartments.

15. The medication package according to claim 11, wherein two pills are arranged in at least one compartment.

16. The medication package according to claim 11, wherein a weakening of the material or a partial material breakthrough is provided in the upper foil and/or the lower foil in the area of at least one line to form a separating aid.

17. The medication package according to claim 11, wherein a print is provided on the upper side of the upper foil and/or on the lower side of the lower foil.

18. The medication package according to claim 11, further comprising a frame that runs around the compartments present and to which the upper foil is directly connected to the lower foil.

19. The medication package according to claim 11, wherein the upper foil and the lower foil consist of the same material.

20. The medication package according to claim 11, wherein the upper foil and the lower foil are welded and/or glued to one another along a plurality of lines.
